(19) United States
(12) Patent Application Publication
(10) Pub. No.: US 2012/0131010 A1
(43) Pub. Date: May 24, 2012

(54) TECHNIQUES TO DETECT VIDEO COPIES

(75) Inventors: Tao Wang, Beijing (CN); Jianguo Li, Beijing (CN); Wenlong Li, Beijing (CN); Yimin Zhang, Beijing (CN)

(73) Assignee: INTEL CORPORATION, Santa Clara, CA (US)

(21) Appl. No.: 13/379,645

(22) PCT Filed: Jun. 26, 2009
(86) PCT No.: PCT/CN2009/000716

§ 371 Date: Feb. 8, 2012

(51) Int. Cl. G06F 17/30

(52) U.S. Cl. 707/743; 707/E17.028

(57) ABSTRACT

Some embodiments include a video copy detection approach based on speeded up robust features (SURF) trajectory building, local sensitive hash (LSH) indexing, and spatial-temporal-scale registration. First, interesting points' trajectories are extracted by SURF. Next, an efficient voting based spatial-temporal-scale registration approach is applied to estimate the optimal transformation parameters (shift and scale) and achieve the final video copy detection results by propagations of video segments in both spatial-temporal and scale directions. To speed up the detection speed, local sensitive hash (LSH) indexing is used to index trajectories for fast queries of candidate trajectories.

### FIELD

The subject matter disclosed herein relates generally to techniques to detect video or image copies.

### RELATED ART

With the increase in the availability of internet and personal videos, video copy detection becomes an active research field in copyright control, business intelligence, and advertisement monitoring. A video copy is a segment of video derived from another video, usually by means of various transformations such as addition, deletion, and modification by shifting, cropping, lighting, contrast, camcording (e.g., changing width/height ratio between 16:9 and 4:3), and/or re-encoding. FIG. 1 shows some examples of video copies. In particular, FIG. 1 depicts in the top row, from left to right: original video, zoom in/out version, and cropped video and in the bottom row, from left to right: shifted video, contrast video, and camcorded and re-encoded video. Re-encoding can include encoding the video with a different codec or compression quality. Because these transformations change spatial-temporal-scale aspects of video, video copy detection becomes a very challenging problem in copyright control and video/image search.

Existing video copy detection work can be categorized into frame-based and clip-based methods. Frame-based approaches assume that a set of key frames are a compact representation of the video contents. In the technique described in P. Duygulu, M. Chen, and A. Hauptmann, “Comparison and Combination of Two Novel Commercial Detection Methods,” Proc. CIVR'04, (July 2004), a set of visual features (color, edge, and Scaled Invariant Feature Transform (SIFT) features) are extracted from these key frames. To detect video copy clips, the technique determines similarity of video segments with these key frames. Frame-based approaches are simple and efficient but not accurate enough because they lose the object's spatial-temporal information (e.g., motion trajectory). In addition, it is difficult to come up with a unified key frame selection scheme for matching two video segments.

Clip-based methods attempt to characterize spatial-temporal features from a sequence of frames. The technique described in J. Yuan, L. Duan, Q. Tian, and C. Xu, “Fast and Robust Short Video Clip Search Using an Index Structure,” Proc. ACM MIR'04 (2004) is an approach in which an ordinal pattern histogram and cumulative color distribution histogram are extracted to characterize the spatial-temporal pattern of the videos. Although this approach explores the video frame's temporal information, the global color histogram feature fails to detect video copies with local transformations, e.g., cropping, shifting, and camcording.

A technique described in J. Law-To, O. Buisson, V. Gouet-Brunet, Nozha Boujemaa, “Robust Voting Algorithm Based on Labels of Behavior for Video Copy Detection,” International Conference on Multimedia (2006) tries to use an asymmetric technique to match the feature points in testing video against interesting points' spatial-temporal trajectories in video database. This approach can detect many video copy transformations, such as shift, light, and contrast. However, the Harris point feature is neither discriminated nor scale invariant, and its spatial-temporal registration can not detect the scale relevant transformations, e.g., zoom in/out and camcording.

### BRIEF DESCRIPTION OF THE DRAWINGS

Embodiments of the present invention are illustrated by way of example, and not by way of limitation, in the drawings and in which like reference numerals refer to similar elements.

FIG. 1 shows some examples of video copies.

FIG. 2 illustrates a video copy detection system, in accordance with an embodiment.

FIG. 3 depicts an exemplary process to create a data base of feature points and trajectories, in accordance with an embodiment.

FIG. 4 depicts an exemplary process to determine video copying, in accordance with an embodiment.

FIG. 5 illustrates an example for voting the optimal offset in the case of one-dimensional bin, in accordance with an embodiment.

FIG. 6 depicts an example of detection of local features from several query video frames, in accordance with an embodiment.

FIG. 7 depicts receive operation characteristic (ROC) curves that described system performance.

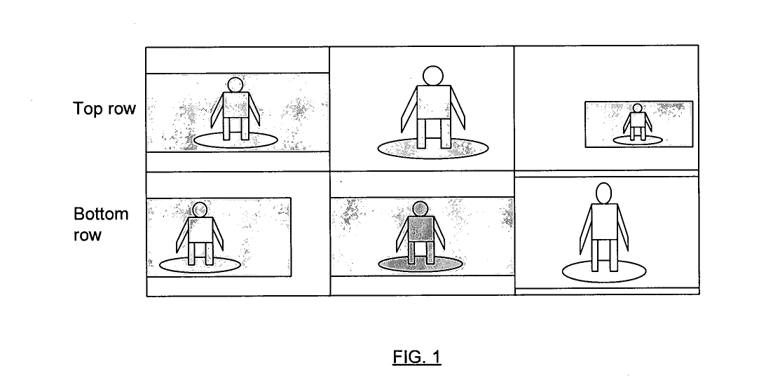

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Various embodiments provide a video copy detection approach based on speeded up robust features (SURF) trajectory building, local sensitive hash indexing (LSH) indexing, and voting-based spatial-temporal-scale registration.

Speeded up robust features (SURF) characterize the interesting points' trajectory features in video copy detection. Various embodiments perform much better than the Harris-features based approach described in the Law-To article. When a false positive frames rate is 10%, the Harris approach's true positive frames rate is 68%, while various embodiments can achieve 90% true positive frames rate. The SURF feature is more discriminating than Harris point features and performs better for scale-relevant transformations, e.g., zoom in/out and camcording, compared to the results from the Law-To article. In addition, the SURF feature extraction is about six times faster than SIFT but provides similar speed as the Harris point feature approach.

Using local sensitive Kash (LSH) indexing provides for fast query of candidate trajectories in video copy detection. The Law-To article describes using probability similarity search rather than LSH indexing.

Through spatial-temporal-scale registration and propagation and merger of offset parameters, matched video segments with the maximum accumulated registration score are detected. The approach in the Law-To article can not detect scale transformations well. By use of this voting-based registration in the discrete offset parameter space, various embodiments are able to detect both spatial-temporal and scale transformations, e.g., cropping, zoom in/out, scale and camcording.

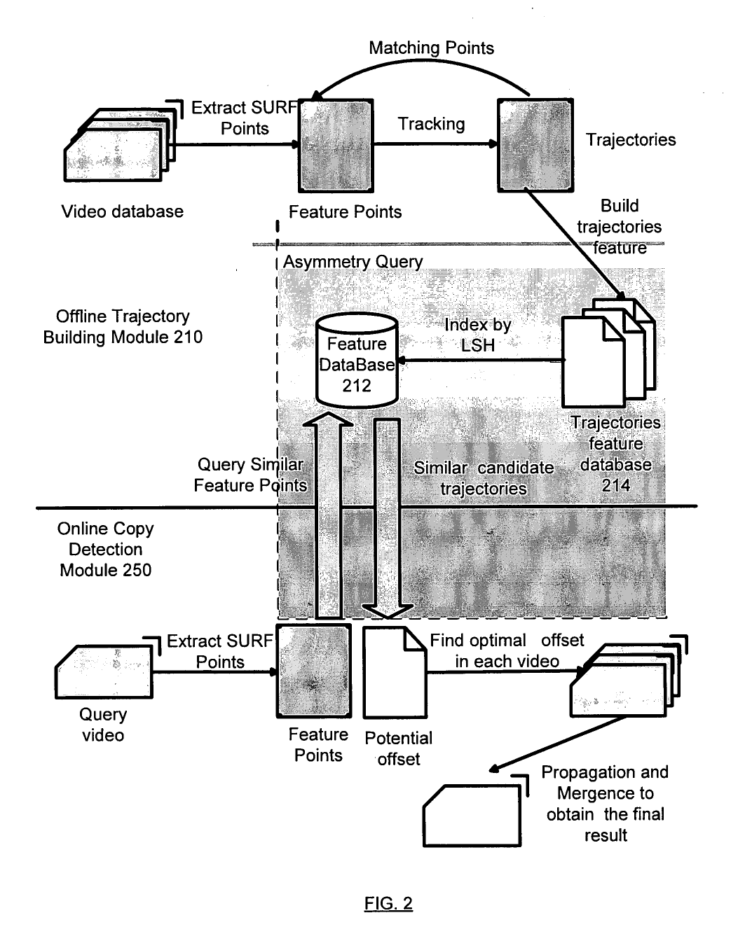

FIG. 2 illustrates a video copy detection system, in accordance with an embodiment. The video copy detection system includes an offline trajectories building module 210 and online copy detection module 250. Any computer system with a processor and memory and that is communicatively coupled to a network via wired or wireless techniques can be configured to perform the operations of offline trajectories building module 210 and online copy detection module 250. For example, query video may be transmitted over a network to the computer system. For example, the computer system may communicate using techniques in compliance with an version of IEEE 802.3, 802.11, or 802.16 using a wire or one or more antennae. The computer system may display video using an display device.

Offline trajectories building module 210 extracts SURF points from every frame of the video database and stores SURF points in a feature database 212. Offline trajectories building module 210 builds a trajectories feature data base 214 that includes trajectories of interesting points. Offline trajectory building module 210 uses LSH to index feature points in feature data base 212 with the trajectories in trajectories feature data base 214.

Online copy detection module 250 extracts the SURF points from sampling frames of a query video. Online copy detection module 250 queries feature data base 212 with the extracted SURF points to identify candidate trajectories with similar local features. Candidate trajectories from trajectories feature database 214 that correspond to the similar feature points are identified using LSH.

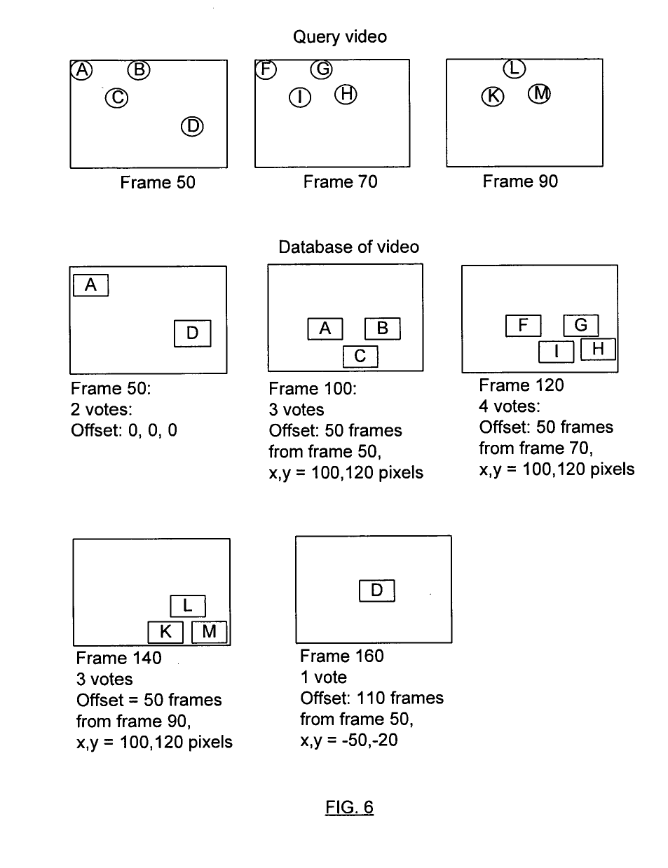

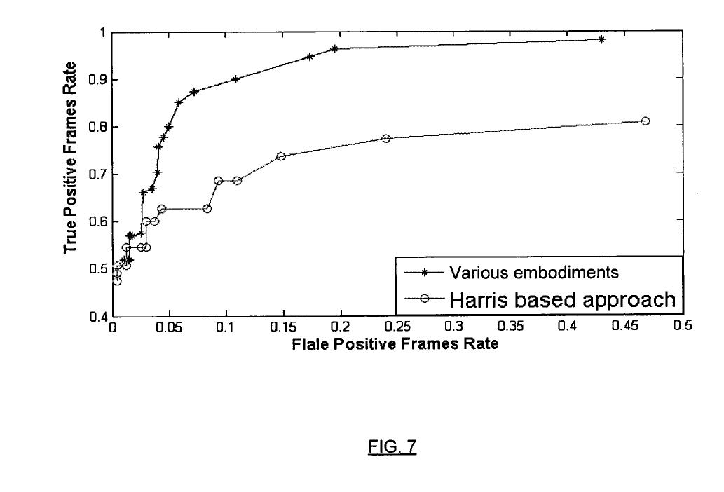

For each feature point from a query video, online copy detection module 250 uses a voting-based spatial-temporal-scale registration approach to estimate an optimal spatial-temporal-scale transformation parameter (i.e., offset) between SURF points in the query video and candidate trajectories in trajectories feature data base 214. Online copy detection module 250 propagates the matched video segments in both spatial-temporal and scale directions to identify video copies. Voting is the accumulation in the spatial-temporal-scale registration space of estimated interesting points. Spatial-temporal-scale registration space is divided into cubes corresponding to shift in x, y, t and scale parameters. Given x, y, t and scale parameters, the number of interesting points found within each cube count as votes. The cube with the highest number of voted interesting points is considered a copy. An example of the voting-based spatial-temporal-scale registration approach is described with regard to FIG. 6.

For example, for a query video Q, M=100 SURF points are extracted every P=20 frames. For each SURF point m on the selected frame k of the query video Q, LSH is used to find N=20 nearest trajectories as the candidate trajectories in trajectories feature database 214. In practice, M, P, and N can be adjusted as a trade-off between the query speed and precision in online copy detection. Each candidate trajectory n is described by Rₘₙ=[Id, Traₙ, Simₘₙ], where Id is the videoID in trajectories feature database 214, Traₙ is the trajectory feature, and Simₘₙ is the similarity between the SURF point at (xₘ,yₘ) and the candidate trajectory's Sₘₑₐₙ feature.

According to associated video Id, the candidate trajectories are categorized into different subsets [symbol] _{I}_{_{d}}. For each video Id in trajectories feature database 214 and the selected query frame k, a fast and efficient spatial-temporal-scale registration method is used to estimate the optimal spatial-temporal-scale registration parameter: Offset(Id, k). After getting the optimal Offset(Id, k), the optimal spatial-temporal-scale offset for potential registered video segments in both spatial-temporal and scale directions are propagated to remove abrupt offsets and get the final detection results.

There are many kinds of transformations in video copy detection. If the query video Q is copied from the same source as a video R of the database, there will be a “constant spatial-temporal-scale offset” between the SURF points of Q and R. Therefore, in various embodiments, the goal of video copy detection is to find a video segment R in the database which have an approximately invariable offset with Q.

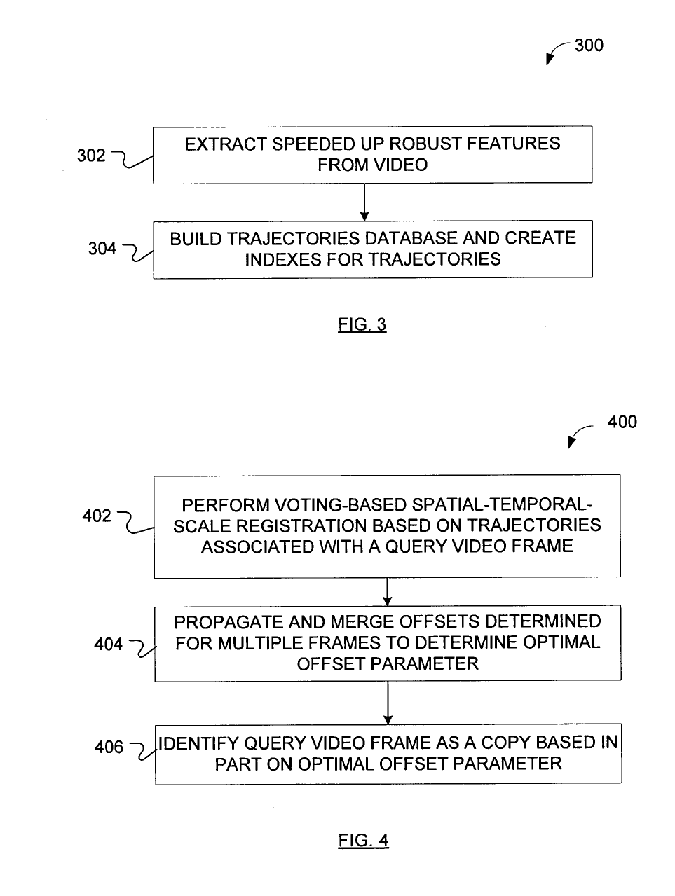

FIG. 3 depicts an exemplary process to create a data base of feature points and trajectories, in accordance with an embodiment. In some embodiments, offline, trajectories building module 210 may perform process 300. Block 302 includes extracting speeded up robust features (SURF) from video. An example of SURF is described in H. Bay, T. Tuytelaars, L. Gool, “SURF: Speeded Up Robust Features,” ECCV, May, 2006. In various embodiments, the extracted features are local features in a frame.

In various embodiments, at each interesting point, the region is split regularly into smaller 3 by 3 square sub-regions. The Haar wavelet responses dₓ, and d_{y} are summed up over each subregion and each subregion has a four-dimensional descriptor vector v=(Σdₓ, Σd_{y}, Σ|dₓ|, Σ|d_{y}|). Therefore, for each interesting point, there is a 36 dimensional SURF feature.

SURF is based on the estimation of a Hessian matrix to construct a Hessian-based detector. SURF employs integral images to speed up the computation time. The speed of SURF extraction is about six times faster than SIFT and provides similar speed to Harris. SURF feature is robust for video copy transformations such as for zoom in/out and cam-cording.

There are many features used in computer vision and image retrieval including global features such as color histogram, ordinal features, and local features, e.g. Harris and SIFT. For video copy detection, global features, such as color histogram features in the entire image frame, can not be used to detect local transformations, e.g. cropping and scale transformation. Various embodiments extract local features from video because local features do not change when video is shifted, cropped, or zoomed in/out.

Block 304 includes building a trajectories database and creating indexes for the trajectories in a video data base. After extracting the SURF points in each frame of the video database, these SURF points are tracked to build trajectories as the video's spatial-temporal features. Each trajectory is represented by Traₙ=[xₘᵢₙ, xₘₐₓ, yₘᵢₙ, yₘₐₓ, tᵢₙ, tₒᵤₜ, Sₘₑₐₙ], n=1, 2, . . . N, where [xₘᵢₙ, xₘₐₓ, yₘᵢₙ, yₘₐₓ, tᵢₙ, tₒᵤₜ] represents the spatial-temporal bounding cube and Sₘₑₐₙ is i the mean of SURF features in the trajectory.

For fast moving points in the x, y directions, the trajectory cube will be too big to discriminate a trajectory's spatial position with others. Therefore, in various embodiments, these trajectories are separated into a few short-time segments, which make the trajectories cube small enough in spatial position due to their short time duration.

For rapid online video copy detection, Local Sensitive Hashing (LSH) is used to index trajectories by their Sₘₑₐₙ features. For example, a query for Sₘₑₐₙ features can be made to index trajectories. With LSH, a small change in the feature space results in a proportional change in the hash value, i.e., the hash function is locality sensitive. In various embodiments, Exact Euclidean LSH (E2LSH) is used to index the trajectories. E2LSH is described for example in A. Andoni, P. lndyk, E2LSH0.1 User manual, June 2000.

FIG. 4 depicts an exemplary process 400 to determine video copying, in accordance with an embodiment. In some embodiments, online copy detection module 250 may perform process 400. Block 402 includes performing voting based spatial-temporal-scale registration based on trajectories associated with a query video frame. The voting based spatial-temporal-scale registration adaptively divides the spatial-temporal-scale offset space into 3D cubes under different scales and votes the similarity Simₘₙ into corresponding cubes. Adaptive division includes changing cube sizes. Each cube corresponds to a possible spatial-temporal offset parameter. For a query frame k, the cube with the maximum accumulation score (i.e., the cube with the most registered trajectories with the interesting points in the query frame k) corresponds to its optimal offset parameter.

Because the candidate trajectory Traₙ's bounding cube is interval-valued data, the spatial-temporal-scale parameter Offset(Id,k) is also interval-valued. Given a scale parameter scale=[scaleₓ, scale_{y}], the Offset^{scale}ₘₙ(Id,k) between the candidate trajectory n in the video Id of a trajectory database and the SURF point m in the selected frame k of the query video is defined as follows:

Offsetₘₙ^{scale}(Id, k)□{[offsetₓ^{min}, Offsetₓ^{max}], [Offset_{y}^{min}, Offset_{y}^{max}], [Offsetₜⁱⁿ, Offsetₜ^{out}], Simₘₙ}={[xₘᵢₙ×scaleₓ−xₘ, xₘₐₓ×scaleₓ−xₘ], [yₘᵢₙ×scale_{y}−yₘ, yₘₐₓ×scale_{y}−yₘ], [tᵢₙ−k, tₒᵤₜ−k], Sim

For example, scaleₓ=scale_{y} ε[0.6, 0.8, 1.0, 1.2, 1.4] to detect general scale transformation such as zoom in/out. Other scale factors can be used. Because camcording transformation has different scale parameters scaleₓ≠scale_{y}, the x, y scale parameters are set as [scaleₓ=0.9, scale_{y}=1.1], and [scaleₓ=1.1, scale_{y}=0.9].

There are thousands of potential offsets Offsetₘₙ^{scale} (Id,k) and the spatial-temporal-scale offset space is too large to search in real time directly. Similar to use of a Hough transformation to vote parameters in discrete space, in various embodiments, a 3-dimentional array is used to vote the similarity score Simₘₙ of Offsetₘₙ^{scale} (Id,k) in discrete spatial-temporal space. Given a scale parameter scale, the spatial-temporal searching space {x, y, t} is adaptively divided into many cubes, where each cube, cubeᵢ, is the basic voting unit.

In some embodiments, the x axis is adaptively divided into many one dimensional bins with different sizes by all the candidate trajectory's start points offsetₓ^{min} and end points offsetₓ^{max}. For each candidate trajectory Trajₙ, the similarity Simₘₙ is accumulated if the interval-valued range Offsetₘₙ has an intersection with the cubeᵢ. Adaptive dividing operations are performed in the y axis and t axis as well.

Based on these cubes, the optimal spatial-temporal registration parameter Offset^{scale}(Id,k) between video Id and query frame k maximizes the accumulated value of compatible queries score(m,n,cubeᵢ) as in the following equation:

$${offset}^{scale} ( Id , k ) = {argmax}_{cubes} Score ( {cube}_{i} )$$

$$Score ( {cube}_{i} ) = {\sum }_{m} {\sum }_{n} Score ( m , n , {cube}_{i} )$$

$$where$$

$${Score}_{cube} ( m , n , {cube}_{i} ) = \{ \begin{matrix}0 & if {Offset}_{mn}^{scale} ⋂ {Cube}_{i} = Φ \\ {Sim}_{mn} & otherwise\end{matrix}$$

Block 404 includes propagating and merging offsets determined from multiple frames to determine an optimal offset parameter. The description accompanying FIG. 6 describes an example of propagating and merging offsets to determine an optimal offset parameter. After determining the spatial-temporal-scale parameter Offset^{scale}(Id,k) in different scales, propagating and merging these Offset^{scale}(Id,k) parameters to obtain the final video copy detection occurs.

After the cube extension in spatial directions, the offset cubes Offset(Id,k) are further propagated in temporal and scale directions. Search takes place in [Offset^{scale}(Id,k−3), Offset^{scale}(Id,k+3)] for seven selected frames to accumulate the spatial intersection, and search takes place in [scale−0.2,scale+0.2] for three scales to obtain robust results corresponding to different scales. Then, the optimal offset Offset(Id,k) is found which has the maximum accumulated voting value in the intersection cubes of these 3*7, or 21 offsets. This propagation step smoothes the gaps among offsets and removes abrupt/error offsets at the same time.

However, because of random perturbations, the real registration offset may be located in the neighbor cubes of the estimated optimal offset. In addition, motionless trajectories will bring some bias to the estimated offset because the intervals of Offsetₓ^{min} and Offsetₓ^{max} (or intervals of Offset_{y}^{min} and Offset_{y}^{max}) are very small to be voted to neighbor cubes. The bias in multi-scale cases also takes place due to noise disturbance and discrete scale parameters. In various embodiments, the optimal offset cube is slightly extended to its neighbor cubes in x, y directions if the scores of these cubes exceed a simple threshold and an estimation is made of the propagated and merged optimal offset at the final video copy detection stage.

Block 406 includes identifying a query video frame as a video copy based in part on the optimal offset. The identified video copy is a sequence of video frames from the database with local SURF trajectory features that are similar to frames in the query and each of the video frames from the database has a similar offset (t, x, y) as that of the query video. In addition, a time offset can be provided that identifies time segments of a video that are potentially copied.

Various embodiments may detect copies of still images. For image copy detection, there are no trajectory and moving information in the temporal direction and accordingly no consideration of temporal offset. However, spatial x,y and scale offset are considered in a similar manner as that of video copy detection. For example, for image copy detection, the SURF interesting points are extracted and indexed. The voting-based approach described with regard to video copy detection can be used to find the optimal offset (x,y, scale) to detect image copies.

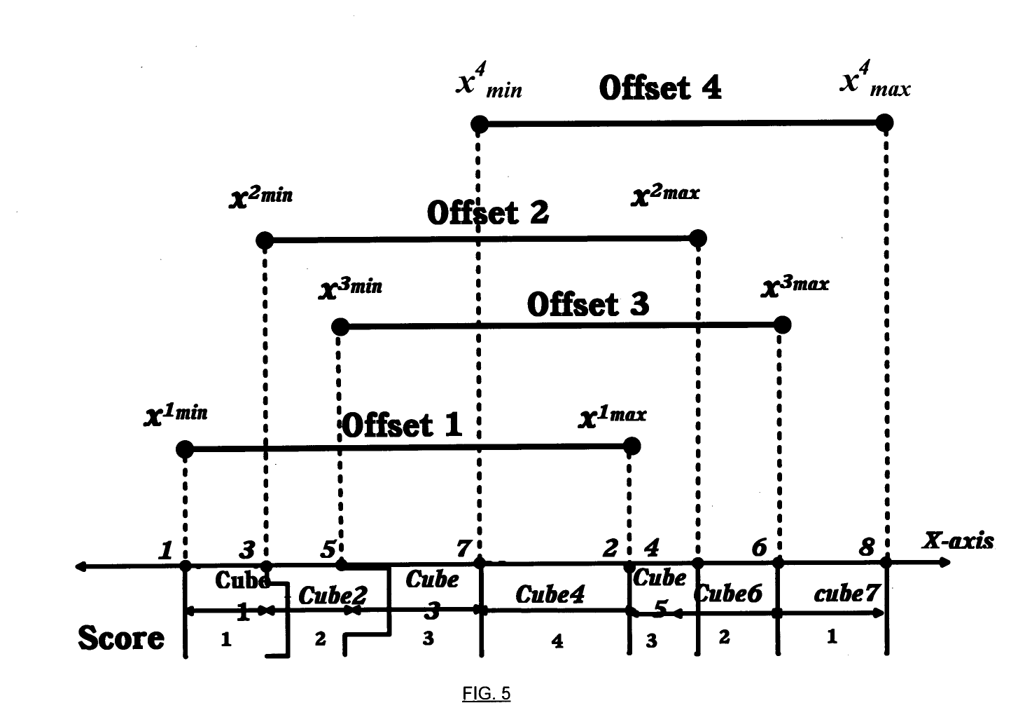

FIG. 5 illustrates a simple example for voting the optimal offset in the case of a one-dimensional bin, in accordance with an embodiment. The x-axis is adaptively divided into seven bins (cubes) by four potential offsets. In this example, the range of the x-axis is x¹min and x⁴max. In this example, each cube represents a range of x offsets. For example, cube 1 represents a first bin that covers offsets between x¹min and x²min. Bins for other offsets are time and y offset (not depicted).

In this example, assuming the Simₘₙ of each potential offset is one, the best offset is cube4[x⁴min, x¹max] and the maximum voting score is four. By comparing these optimal offsets Offset^{scale}(Id,k) in different scales, the optimal spatial-temporal-scale registration parameter Offset(Id,k) is estimated with the maximum voting score in all scales.

FIG. 6 depicts an example of detection of local features from several query video frames, in accordance with an embodiment. The circles in the query video frames represent interesting points. The rectangles in the frames of the database of video represent bounding cubes in the (t, x, y) dimensions. A cube from FIG. 5 represents a single dimension (i.e., t, x, or y). To estimate scale transformation parameters, the spatial-temporal registration in the 3D (x, y, t) voting space is applied for each discrete scale value separately (scaleₓ=scale_{y} ε[0.6, 0.8, 1.0, 1.2, 1.4]) and the detection results are combined.

In this example, a determination is made if local features from query frames at times 50, 70, and 90 appear in frames in a video database. The query frame at time 50 includes local feature A-D. A frame at time 50 from the video database includes local features A and D. Accordingly, two votes (i.e., one vote for each local feature) are attributed to frame 50 from the video database. The (t, x, y) offset is (0, 0, 0) because the local features A and D appear at the same time and in substantially similar positions.

The query frame at time 70 includes local features F-I. The frame at time 120 from the video database includes local features F-I. Accordingly, four votes are attributed to frame 120 from the video database. The (t, x, y) offset is (50 frames, 100 pixels, 120 pixels) because the local features F-I appear 50 frames later and shifted down and to the right.

The query frame at time 90 includes local features K-M. The frame at time 140 from the video database includes local features K-M. Accordingly, three votes are attributed to frame 140 from the video database. The (t, x, y) offset is (50 frames, 100 pixels, 120 pixels) because the local features K-M appear 50 frames later and shifted down and to the right.

The query frame at time 50 includes local feature D. The frame at time 160 from the video database includes local feature D. Accordingly, one vote is attributed to frame 160 from the video database. The (t, x, y) offset is (110 frames, −50 pixels, −20 pixels) because the local feature D appears 110 frames later and shifted up and to the left.

Frames 100, 120, and 140 from the video database have similar offset (t, x, y). In other words, with reference to the scheme of FIG. 5, offsets from frames 100, 120, and 140 fit within the same cube. The optimal offset is the offset associated with multiple frames. Frames with similar offset are merged into a continuous video clip.

To evaluate the performance of various embodiments, extensive experiments are conducted on 200 hours of MPEG-1 videos which are randomly taken from INA (the French Institut National de I'Audiovisuel) and TRECVID2007 video dataset. The video database is divided into two parts: the reference database and the non-reference database. The reference database is 70 hours of 100 videos. The non-reference database is 130 hours of 150 videos.

Two experiments were conducted to evaluate the system performance. Running on a Pentium IV 2.0 GHz with 1G RAM, the reference video database has 1,465,532 SURF trajectories records off-line indexed by LSH. The online video copy detection module extracts M=100 SURF points at most in each sampled frame of the query video. The spatial-temporal-scale offset is calculated every p=20 frames. For each query SURF point, it takes about 150ms to find N=20 candidate trajectories by LSH. The spatial-temporal-scale registration costs about 130 ms to estimate the optimal offset in 7 scale parameters.

In the experiment 1, the video copy detection performance was compared for different transformations respectively on the SURF feature and Harris feature. Twenty query video clips are randomly extracted just from the reference database and the length of each video clip is 1000 frames. Then each video clip is transformed by different transformations to create the query video, e.g., shift, zoom aspect.

Table 1 depicts a comparison of the video copy detection approach for different transformations respectively on the SURF feature and Harris feature.

TABLE 1

| | | Query videos | Query videos |
|---|---|---|---|
| | | detected from | detected from |
| | Number | reference | reference |
| | of query | database/frames | database/frames |
| | videos/total | from query video | from query video |
| | frames in query | detected by | detected by |
| Transformations | video | Harris technique | SURF technique |
| Shift | 20/20,000 | 20/10,080 | 20/14,460 |
| Cropping | 20/20,000 | 20/8,240 | 20/13,640 |
| Zoom in | 20/20,000 | 14/4,240 | 20/14,280 |
| Zoom out | 20/20,000 | 15/2,820 | 20/12,820 |
| Camcording | 20/20,000 | 9/1,580 | 20/12,400 |

From Table 1, it can be observed that SURF feature outperform Harris feature about 25-50% for zoom in/out and camcording transformations. In addition, although SURF feature has similar performance to Harris on shift and cropping transformations. In addition, use of the SURF feature can detect more copied frames about 21%-27% than Harris features.

To test more complex data in practice, the SURF feature based spatial-temporal-scale registration approach is compared with the Harris feature based video copy detection approach described in J. Law-To's article. The query video clips consists of 15 transformed reference videos and 15 non-reference videos, which total up to 100 minutes (150,000 frames). The reference videos are transformed by different transformations with different parameters than experiment 1.

FIG. 7 depicts receive operation characteristic (ROC) curves that described system performance. It can be observed that various embodiments perform much better than the Harris features-based approach in J. Law-To's article. When false positive frames rate is 10%, Harris approach's true positive frame rates is 68% while methods of various embodiments can achieve 90% true positive frames rate. In J. Law-To's article's report, the true positive frame rates is 82% when false positive frames rate is 10%. However, J. Law-To's article also mentioned that the scale transformation is limited in 0.95-1.05. The higher performance of various embodiments contributes to robust SURF feature and efficient spatial-temporal-scale registration. In addition, propagation and mergence is also very useful to propagate the detected video clips as long as possible and smooth/remove abrupt and error offsets.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
extracting speeded up robust features (SURF) from reference video;
storing SURF points from the reference video;
determining trajectories as the reference video's spatial-temporal features based on the SURF points;
storing the trajectories; and
creating indexes for the trajectories.

2. The method of claim 1, wherein extracted SURF comprises local features of the reference video.

3. The method of claim 1, wherein creating indexes comprises applying Local Sensitive Hashing (LSH) to determine an index of trajectories by a mean of SURF features.

4. The method of claim 1, further comprising:
determining SURF of a query video;
determining an offset associated with query video frames; and
determining whether the query video frames comprise a video copy clip based in part on the determined offset.

5. The method of claim 4, wherein the determining an offset comprises adaptively dividing a spatial-temporal offset space into cubes, wherein each cube corresponds to a possible spatial-temporal offset parameter of time, x, or y offset.

6. The method of claim 5, wherein the determining an offset further comprises:
determining trajectories of reference video frames associated with the query video frames; and
for each scale of a spatial-temporal offset, accumulating a number of similar local features between the query video frames and reference video frames.

7. The method of claim 4, wherein determining whether the query video frames comprise a video copy clip comprises:
identifying reference video frames with local features that are similar to the extracted SURF from the query video and wherein local features of each video frame of the identified reference video frames have a similar time and spatial offsets from the SURF of the query video.

8. An apparatus comprising:
a feature data base;
a trajectories feature data base; and
a trajectory building logic to:
extract speeded up robust features (SURF) from a reference video,
store the features in the feature data base,
track SURF points to form trajectories of the reference video's spatial-temporal features,
store the trajectories in the trajectories feature data base, and
create indexes for the trajectories feature data base.

9. The apparatus of claim 8, wherein the trajectory building logic is to:
receive a query request for features of a query video and
provide trajectories associated with the features of the query video.

10. The apparatus of claim 8, wherein extracted SURF comprises local features of the reference video.

11. The apparatus of claim 8, wherein to create indexes for the trajectories feature data base, the trajectory building logic is to apply Local Sensitive Hashing (LSH) to index trajectories by the mean of SURF features.

12. The apparatus of claim 8, further comprising:
a copy detection module to:
extract SURF from a query video,
receive trajectories associated with the features of the
query video from the trajectory building logic, and
identify reference video frames from the feature database, the reference video frames having local features that are similar to the extracted SURF from the query video and wherein local features of each video frame of the identified reference video frames have a similar time and spatial offsets from the SURF from the query video.

13. The apparatus of claim 12, wherein to identify reference video frames, the copy detection module is to:
determine an offset associated with query video frames; and
determine whether the query video frames comprise a video copy clip based in part on the determined offset.

14. The apparatus of claim 13, wherein to determine an offset, the copy detection module is to adaptively divide a spatial-temporal offset space into cubes, wherein each cube corresponds to a possible spatial-temporal offset parameter of time, x, or y offset.

15. The apparatus of claim 14, wherein to determine an offset, the copy detection module is also to:
determine trajectories of reference video frames associated with the query video frames; and
for each scale of a spatial-temporal offset, accumulate a number of similar local features between the query video frames and reference video frames.

16. The apparatus of claim 13, wherein to determine whether the query video frames comprise a video copy clip, the copy detection module is to:
identify reference video frames with local features that are similar to the extracted SURF from the query video and wherein local features of each video frame of the identified reference video frames have a similar time and spatial offsets from the SURF of the query video.

17. A system comprising:
a display device and
a computer system communicatively coupled to the display device, the computer system comprising:
a feature data base;
a trajectories feature data base; and
a trajectory building logic to:
extract speeded up robust features (SURF) from a reference video,
store the SURF in the feature data base,
determine trajectories of the reference video's spatial-temporal features based on the SURF points, and
store the trajectories in the trajectories feature data base; and
copy detection logic to:
determine whether frames of a query video are copies and
provide video frames from the reference video that are similar to frames of the query video.

18. The system of claim 17, wherein extracted SURF comprises local features of the reference video.

19. The system of claim 17, wherein the trajectory building logic is also to create indexes for trajectories associated with extracted SURF by applying Local Sensitive Hashing (LSH) to index trajectories by a mean of the extracted SURF.

20. The system of claim 17, wherein to determine whether frames of a query video are copies, the copy detection logic is to:
identify reference video frames with local features that are similar to the extracted SURF from the query video and wherein local features of each video frame of the identified reference video frames have a similar time and spatial offsets from the SURF of the query video.

21. A method comprising:
extracting speeded up robust features (SURF) from a reference image;
determining trajectories of the reference video's spatial features based on the SURF points;
storing the trajectories; and
creating indexes for the stored trajectories.

22. The method of claim 21, wherein extracted SURF comprises local features of the reference image.

23. The method of claim 21, wherein creating indexes comprises applying Local Sensitive Hashing (LSH) to index trajectories by the mean of SURF features.

24. The method of claim 21, wherein determining whether a query image is a copy comprises:
identifying reference images with local features that are similar to the extracted SURF from the query image and wherein local features of each identified reference video image has a similar spatial offset from the SURF of the query image.
